(19) United States
(12) Patent Application Publication
(10) Pub. No.: US 2018/0237297 A1
(43) Pub. Date: Aug. 23, 2018

(54) METHOD AND SYSTEM FOR OBTAINING A HYDROGEN RICH GAS

(71) Applicant: SHELL OIL COMPANY, HOUSTON, TX (US)

(72) Inventors: Julie Hélène Emond DUNCAN, Amsterdam (NL); Arjan Allert JONCKERS, Amsterdam (NL); Sanjay Madhoprasad RUNGTA, Amsterdam (NL)

(21) Appl. No.: 15/549,682

(22) PCT Filed: Feb. 8, 2016
(86) PCT No.: PCT/EP2016/052646

§ 371 Date: Aug. 9, 2017

(30) Foreign Application Priority Data
Feb. 10, 2015 (EP) 15154564.7

(51) Int. Cl. C01B 3/48; C01B 3/56

(52) U.S. Cl. CPC C01B 3/48; C01B 3/56; C01B 2203/0216; C01B 2203/0283; C01B 2203/042; C01B 2203/146; C01B 2203/0288; C01B 2203/0294; C01B 2203/047; C01B 2203/0475; C01B 2203/062; C01B 2203/043

(57) ABSTRACT

The present invention relates to a method for obtaining a hydrogen rich gas from a natural gas comprising gas stream. The present invention relates to a system for obtaining a hydrogen rich gas from a gas stream comprising natural gas. The invention can be used in a chemical plant for hydrocarbon synthesis.

### FIELD OF THE INVENTION

The present invention relates to a method for obtaining a hydrogen rich gas from a natural gas comprising gas stream. The present invention relates to a system for obtaining a hydrogen rich gas from a gas stream comprising natural gas.

### BACKGROUND TO THE INVENTION

Synthesis reactions of hydrocarbons from synthesis gas such as the Fischer-Tropsch process can be used for the conversion of hydrocarbonaceous feed stocks into normally liquid and/or solid hydrocarbons (i.e. measured at 0° C., 1 bar). The feed stock (e.g. natural gas, associated gas, coal-bed methane, residual oil fractions, biomass and/or coal) is converted in a first step into a mixture of hydrogen and carbon monoxide. This mixture is often referred to as synthesis gas or syngas. The synthesis gas is fed into a reactor where it is converted over a suitable catalyst at elevated temperature and pressure into paraffinic compounds ranging from methane to high molecular weight molecules comprising up to 200 carbon atoms, or, under particular circumstances, even more. The hydrocarbon products manufactured in the Fischer-Tropsch process are processed into different fractions, for example a liquid hydrocarbon stream comprising mainly C5+ hydrocarbons, and a gaseous hydrocarbon stream which comprises methane, carbon dioxide, unconverted carbon monoxide, unconverted hydrogen, olefins and lower hydrocarbons. The gaseous hydrocarbon stream may also comprise nitrogen and/or argon as the syngas sent to the Fischer-Tropsch reactor may contain some nitrogen and/or argon.

The gaseous hydrocarbon stream is often referred to as Fischer-Tropsch off-gas. Fischer-Tropsch off-gas can be recycled to the syngas manufacturing or to the Fischer-Tropsch reactor. Sometimes lower hydrocarbons are removed before the off-gas is recycled. Lower hydrocarbons may be removed by decreasing the temperature of the off-gas and then applying a gas-liquid separation.

However, when the off-gas is recycled to the syngas manufacturing or to the Fischer-Tropsch reactor, the components in the off-gas which do not take part in the reactions, such as nitrogen and argon, occupy reactor space. The components which do not take part in the Fischer-Tropsch reaction are also referred to as “inerts”.

The level of inerts in the Fischer-Tropsch reactor increases with increasing Fischer-Tropsch off-gas recycling. It is common to recycle only a relatively small part of the off-gas. One possibility is to recycle a part of the Fischer-Tropsch off-gas to one or more Fischer-Tropsch reactors and/or to the synthesis gas manufacturing unit, while another part of the off-gas is used as fuel. A downside of this is that only a part of the carbon atoms of the hydrocarbonaceous feed stock is converted to the desired C5+ hydrocarbons. The pace of the build-up of inerts can be reduced by treating the off-gas before it is recycled.

US20110011128 describes a PSA comprising system in which purified hydrogen is produced using a PSA, which may be a conventional co-purge H2 PSA unit. Such a system may be useful to a hydrogen-rich gas mixture exiting a steam methane reformer, but is not suitable to treat nitrogen comprising hydrogen-lean off-gas of a Fischer-Tropsch process.

US20040077736 mentions a process in which a liquid phase and a vapour phase are withdrawn from a hydrocarbons synthesis stage. In a vapour phase work-up stage, hydrocarbon products having 3 or more carbon atoms may be removed and the residual vapour phase may then pass to a PSA. Using the PSA first, second and optionally third gas components are separated. The first gas component comprises carbon monoxide and hydrogen. The second gas component comprises methane, and the optional third gas component comprises carbon dioxide. The first gas component is recycled to the hydrocarbon synthesis stage. US20040077736 does not provide details on the PSA method used. A regular use of a normal PSA would result in a relatively low recovery of carbon monoxide in the first gas component, and a build-up of nitrogen in the reactor upon recycling the first gas component to the hydrocarbon synthesis stage.

US20080300326-A1 describes the use of a PSA method to separate Fischer-Tropsch off-gas. The method produces at least one gas stream comprising hydrogen, at least one gas stream mainly comprising methane, and at least one gas stream comprising carbon dioxide, nitrogen and/or argon, and hydrocarbons with at least 2 carbon atoms. The PSA used comprises at least three adsorbent beds: alumina, carbon molecular sieves or silicates, activated carbon, and optionally zeolite. The alumina is used to remove water. The carbon molecular sieves or silicates are used to adsorb carbon dioxide and partially methane. The activated carbon is used to adsorb methane and partially nitrogen and carbon monoxide. Zeolite may be used to adsorb nitrogen, argon and carbon monoxide. The product stream of the PSA mainly comprises hydrogen. The other gas streams are obtained during the decompression phase. Disadvantages of the method of

US20080300326-A1 are at least the following. Nitrogen is only partially adsorbed in the PSA. This results in a build-up of nitrogen in the Fischer-Tropsch reactor when the hydrogen stream is used, i.e. recycled, as reactant gas. Also the methane stream comprises nitrogen and thus results in the build-up of nitrogen in the syngas, and thus in the Fischer-Tropsch reactor, when the methane stream is used for generating syngas. Another disadvantage of the method of US20080300326-A1 is that carbon monoxide is only recycled to the Fischer-Tropsch reactor in a limited amount. Carbon monoxide is present in the hydrogen stream and in the methane stream.

Hydrogen is utilized abundantly in chemical plants such as GTL plants. Hence there is continued desire in the field to produce hydrogen as efficiently as possible. Since hydrogen is one of the most valued components there is also a continued desire in the field to use hydrogen as efficiently as possible.

### SUMMARY OF THE INVENTION

It is an object of the present invention to provide for a method to produce hydrogen efficiently.

Further, it is an object of the present invention to increase the efficiency of the use of hydrogen in a chemical plant.

One or more of the above objects is achieved by treating natural gas according to the present invention. The present invention relates to a method for obtaining a hydrogen rich gas from a natural gas comprising gas stream. Said method comprises the following steps:
(1) feeding said natural gas comprising gas and an appropriate amount of steam to a reforming unit comprising at least a steam methane reformer (SMR) and optionally a pre-reforming reactor up stream of the SMR, obtaining a first effluent;
(2) feeding said first effluent and optionally an appropriate amount of steam through a high, medium or low temperature shift reactor(s) or a combination thereof to convert at least part of the carbon monoxide and water into hydrogen and carbon dioxide, to obtain a second effluent;
(3) optionally, removing bulk water from the second effluent obtained in steps (1) or (2);
(4) feeding the second effluent of step (2)and/or (3) through a pressure swing adsorption (PSA) unit operated such that a hydrogen rich gas stream is obtained;
wherein an off gas is added to the natural gas comprising gas stream and/or the first effluent obtained in step (1),
wherein the off gas provided upstream of the reforming unit is mixed with steam prior to being added to the natural gas comprising gas stream.

The inventors have found that one or more of the objects can be achieved by feeding a natural gas comprising gas stream to a system according to the present invention. Said system comprises, connected in series:
one or more reforming units, each unit comprising at least a steam methane reforming reactor;
one or more high, medium or low temperature shift reactor(s) or a combination thereof to convert at least part of the carbon monoxide and steam into hydrogen and carbon dioxide; and
one or more pressure swing adsorption units.

The system allows for the manufacturing of a hydrogen rich gas from a gas stream comprising natural gas.

### DETAILED DESCRIPTION OF THE INVENTION

As described above the present invention relates to a method for obtaining a hydrogen rich gas from a natural gas comprising gas stream. The method according to the present invention comprises the following steps:
(1) feeding said gas and an appropriate amount of steam to a reforming unit comprising a steam methane reforming reactor, obtaining a first effluent;
(2) feeding said first effluent and optionally an appropriate amount of steam through a high, medium or low temperature shift reactor(s) or a combination thereof to convert at least part of the carbon monoxide and water into hydrogen and carbon dioxide, to obtain a second effluent;
(3) optionally, removing bulk water from the second effluent obtained in step (2);
(4) feeding the second effluent of step (2)and/or (3) through a pressure swing adsorption (PSA) unit operated such that a hydrogen rich gas stream is obtained.

In step (1) a natural gas comprising gas stream is mixed with steam and fed through a steam methane reforming reactor. At the exit of the SMR reactor a first effluent exits. The reactor is operated such that mainly hydrogen and carbon monoxide is formed. In case only natural gas is fed through the reactor, the first effluent consists mainly of synthesis gas. With synthesis gas (also named syngas) is meant a gas comprising hydrogen and carbon monoxide. Small amounts of unconverted (residual) methane may be present in the first effluent. Further, inert compounds such as nitrogen and argon may be present in the first effluent.

In a preferred embodiment the inlet temperatures of the SMR reactor are between 830 and 1000° C., preferably between 830 and 930° C. In these ranges good conversion results are obtained.

Preferably, the SMR is operated at a pressure ranging from 15 barg to 50 barg. At these pressures good conversion results are obtained.

SMR reactors are commercially available from (amongst others) Haldor Topsoe A/S and The Linde Group.

In step (2) the first effluent is fed through a high, medium or low temperature shift reactor(s) or a combination thereof. In the shift reactor at least part of the carbon monoxide and water is converted into hydrogen and carbon dioxide. Hence, compared to the hydrogen content of the first effluent, the hydrogen content of the second effluent is increased.

Prior to feeding the second effluent to the Pressure Swing Adsorption (PSA) unit excess water can be removed (step (3)). After feeding the second effluent of step (2) and/or (3) through a pressure swing adsorption (PSA) unit operated such that a hydrogen rich gas stream is obtained.

Preferably, the hydrogen rich gas stream consist for at least 80 vol % out of hydrogen, more preferably for at least 90 vol % and even more preferred is at least 99 vol %.

The method according to the invention is performed by operating a system for obtaining a hydrogen rich gas from a gas stream comprising natural gas, comprising, connected in series:
one or more reforming units, each unit comprising at least a steam methane reforming reactor;
one or more high, medium or low temperature shift reactor(s) or a combination thereof to convert at least part of the carbon monoxide and steam into hydrogen and carbon dioxide; and
one or more pressure swing adsorption units. This system is also an embodiment of the present invention.

In an embodiment of the invention step 4 comprises the following steps:
(A) feeding the second effluent obtained in step (2)and/or (3) through one or more columns in the PSA unit, said one or more columns comprising an adsorbent bed, wherein the adsorbent bed comprises alumina, a carbon molecular sieve, silicalite, activated carbon, a zeolite, or mixtures thereof,
   with upon commencement of said feeding, the bed and column being pre-saturated and pre-pressurized to a pressure in the range of 20 to 80 bar absolute (bar a), preferably 30 to 70 bar a, with a gas preferably comprising or consisting of the second effluent of step (2) and/or (3) a gas comprising 80 to 99.9 volume % hydrogen; and
   discharging a third effluent from the other end of said bed, and
   continuing said feeding and said discharging until a nitrogen and/or argon comprising gas has reached at least 45% of the length of the bed and has reached at most 80% of the length of the bed, calculated from the end of the bed at which the second effluent is being fed;
(B) ceasing the feeding of the second effluent, and reducing the pressure in the column and the bed by about 2 to 25 bar a; and
(C) further reducing the pressure of the column and adsorbent bed to a pressure in the range of 1 to 5 bar a; and
(D) rinsing the column and adsorbent bed by feeding a gas, preferably comprising 80 to 99.9 volume % hydrogen, through the column and adsorbent bed:
   the column and bed being at a pressure in the range of 1 to 5 bar a; and
(E) pressurizing the column and adsorbent bed to a pressure in the range of 15 to 75 bar a, preferably 25 to 65 bar a, more preferably 30 to 55 bar a by feeding a gas, preferably comprising or consisting of the second effluent of step (2) and/or (3) or comprising 80 to 99.9 volume % hydrogen.

The third effluent is enriched in hydrogen and contains at least 80 vol %, and preferably at least 90 vol %, and more preferably at least 99 vol % hydrogen and preferably up to 99.9 vol % hydrogen.

A fourth effluent is obtained by rinsing the column and contains primarily carbon dioxide and inerts and residual carbon monoxide, hydrogen and methane.

Optionally, in step (D) the column is first rinsed with effluent from step (B) before it is rinsed by feeding a gas comprising more than 80 volume % hydrogen, preferably a gas comprising more than 95 volume % hydrogen and more preferably more than 99.9 volume % hydrogen, through the column and adsorbent bed.

The hydrogen fed to the column and bed in step (D) rinses the bed from nitrogen and/or argon. The pressure of the effluent gas will be about the same as the pressure in the column and the adsorbent bed and will thus be in the range of 1 to 5 bar a. The effluent can be sent to a fuel pool.

In step (E) the column and adsorbent bed are pressurized to a pressure in the range of 15 to 75 bar a, preferably 25 to 65 bar a, more preferably 30 to 55 bar a by feeding a hydrogen containing gas. In step (E), the hydrogen containing gas preferably is a part of the product hydrogen from step (A)and/or the second effluent.

Optionally, the hydrogen fed to the column in steps (D) and (E) is pure hydrogen. The hydrogen fed to the column in steps (D) and (E) preferably is a gas comprising more than 80 volume % hydrogen, more preferably a gas comprising more than 95 volume % hydrogen and more preferably more than 99.9 volume % hydrogen. Rinsing step (D) may be performed with product hydrogen comprising gas of steps (A) or (B).

In a preferred embodiment of the present invention an off gas is added to the natural gas comprising gas stream and/or the first effluent obtained in step (1), said off gas is preferably generated by a synthesis reaction of hydrocarbons from synthesis gas, preferably a Fischer-Tropsch reaction, preferably said off gas is provided to the natural gas comprising gas stream and the first effluent obtained in step (1). The inventors have found that treating a combination of off gas and natural gas, according to the present invention is a very efficient way of producing hydrogen.

Rather than recovering carbon monoxide, a carbon monoxide shift reactor can be used to increase the hydrogen content of the off-gas.

The Fischer-Tropsch off-gas may comprise gaseous hydrocarbons, nitrogen, argon, methane, unconverted carbon monoxide, carbon dioxide, unconverted hydrogen and water. The gaseous hydrocarbons are suitably C1-C5 hydrocarbons, preferably C1-C4 hydrocarbons, more preferably C1-C3 hydrocarbons. These hydrocarbons, or mixtures thereof, are gaseous at temperatures of 5-30° C. (1 bar), especially at 20° C. (1 bar). Further, oxygenated compounds, e.g. methanol, dimethylether, may be present.

In most cases the Fischer-Tropsh off-gas will contain 5-80 vol % hydrogen, preferably 8-25 vol % hydrogen, 10-45 vol % CO, preferably 15-40 vol % CO, 10-65 vol % CO₂, preferably 10-35 vol % CO₂, 0.5-55 vol % N₂, preferably 1-20 vol % N₂ and 0-55 vol % argon, preferably 0.1 to 55 vol % argon, calculated on the total volume of the dry gas mixture. Depending on the syngas feed and the Fischer-Tropsch conditions the composition of the Fischer-Tropsch off-gas can vary. Obviously, the total volume of the gas mixture is 100 vol %.

In a preferred embodiment the off gas is fed through the steam methane reforming reactor in step (1) and/or through the high, medium or low temperature shift reactor(s) in step (2).

Hence, in an embodiment of the invention, off gas and steam is added simultaneously to the gas stream.

In case a high temperature shift reactor is used the inlet temperature of the gas stream entering the reactor is within the range of 300-350° C.

In an embodiment of the invention, the off gas provided upstream of the reforming unit is mixed with steam prior to being added to the natural gas comprising gas stream.

The obtained gas mixture of natural gas, off gas and steam, is fed through the steam methane reformer. As mentioned previously, in the SMR reactor methane is converted into hydrogen (H₂) and carbon monoxide (CO). Hence the effluent leaving the reactor comprises hydrogen, carbon monoxide and compounds such as inerts, residual methane and carbon dioxide.

In an embodiment of the invention off gas is added to the effluent of the SMR reactor to obtain a gas mixture comprising the effluent and the off gas. This mixture is fed through a high, medium or low temperature shift reactor(s) or a combination thereof. At least, part of the carbon monoxide and water present in the gas mixture is converted into hydrogen and carbon dioxide.

In an embodiment off gas is added to both the natural gas comprising gas stream, upstream of the SMR reactor and to the effluent of the SMR reactor. Hence, in accordance with this embodiment off gas is added to the gas streams both upstream and downstream of the SMR reactor(s).

In an embodiment only a gas stream based on natural gas is fed to the SMR reactor. The main component of natural gas is methane but also other compounds can be present such as higher alkanes and nitrogen. Preferably, the natural gas used is desulfurized prior to feeding it through the SMR reactor.

In an embodiment of the present invention the off gas comprises (in volume percentage based on the total volume of the off gas):

| | | |
|---|---|---|
| Methane | 1-50 | vol %; |
| Carbon Monoxide | 10-45 | vol %; |
| Carbon Dioxide | 10-65 | vol %; |
| Hydrogen | 5-80 | vol %; |
| Nitrogen | 0.5-55 | vol %; |
| Argon | 0-55 | vol %. |

In an embodiment of the present invention the gas fed to the high, medium or low temperature shift reactor(s) or a combination thereof comprises (in volume percentage based on the total volume of the gas fed):

| | | |
|---|---|---|
| Methane | 1-50 | vol %; |
| Carbon Monoxide | 5-45 | vol %; |
| Carbon Dioxide | 5-65 | vol %; |
| Hydrogen | 5-80 | vol %; |
| Nitrogen | 0.001-55 | vol %; |
| Argon | 0-55 | vol %. |

In an embodiment of the present invention the second effluent comprises (in volume percentage based on the total volume of the second effluent):

| | | |
|---|---|---|
| Methane | 4-20 | vol %; |
| Carbon Monoxide | 1-10 | vol %; |
| Carbon Dioxide | 10-40 | vol %; |
| Hydrogen | 40-95 | vol %; |
| Nitrogen | 0.001-10 | vol %; |
| Argon | 0.0001-5 | vol %. |

The present invention relates to a system for performing the method according to the invention. Said system comprises, connected in series:

one or more reforming units, each unit comprising at least a steam methane reforming reactor and optionally a pre reforming reactor;

one or more high, medium or low temperature shift reactor(s) or a combination thereof to convert at least part of the carbon monoxide and steam into hydrogen and carbon dioxide; and

one or more pressure swing adsorption units. This system is also an embodiment of the present invention.

The system according to the present invention for obtaining a hydrogen rich gas from a gas stream comprising natural gas, comprises a pressure swing adsorption unit which comprises:

one or more columns, comprising an adsorbent bed, wherein the adsorbent bed comprises alumina, a carbon molecular sieve, silicalite, activated carbon, a zeolite, or mixtures thereof.

Preferably the PSA columns are operated in accordance with steps (A) to (E). The inventors have found that hydrogen gas can be efficiently separated from the other constituents of the second effluent by performing these steps.

Preferably, the system comprises upstream of the one or more steam methane reforming reactors an inlet for adding off gas to the natural gas stream. A second inlet for adding steam can also be present upstream of the SMR reactor(s). Said off gas preferably originates from one or more hydrocarbon synthesis reactor(s) such as a Fischer-Tropsch reactor(s). The inventors have found that with the system according to the present invention off gas in combination with natural gas can be used to efficiently produce hydrogen gas.

Preferably, the system according to the present invention comprises upstream of one or more high, medium or low temperature shift reactor(s) or a combination thereof, an inlet for adding off gas to the first effluent wherein the off gas originates from a hydrocarbon synthesis reactor such as a Fischer-Tropsch reactor.

Preferably, the system according to the present invention comprises:

a further PSA unit comprising one or more columns provided down-stream of the first PSA unit, said one or more columns comprising an adsorbent bed, the adsorbent bed comprising alumina, a carbon molecular sieve, silicalite, activated carbon, a zeolite, or mixtures thereof.

Said second unit can be used to separate one or more of the constituents of the gas mixture left after the first PSA separation step performed by the first PSA unit.

In an embodiment of the invention the reforming unit further comprises a pre-reforming reactor. Hence according to this embodiment the reforming unit comprises, connected in series, a pre reformer reactor and an SMR reactor. In the pre reformer part of the methane is converted into hydrogen and carbon monoxide. In case a pre reformer is applied the inlet temperature at the SMR can be reduced to below 830° C. and preferably to below 700° C.

The invention will be further illustrated by the figures. The figures represent preferred embodiments of the invention and are not intended to limit the present invention.

FIG. 1 schematically depicts a system according to the present invention with no off gas added.

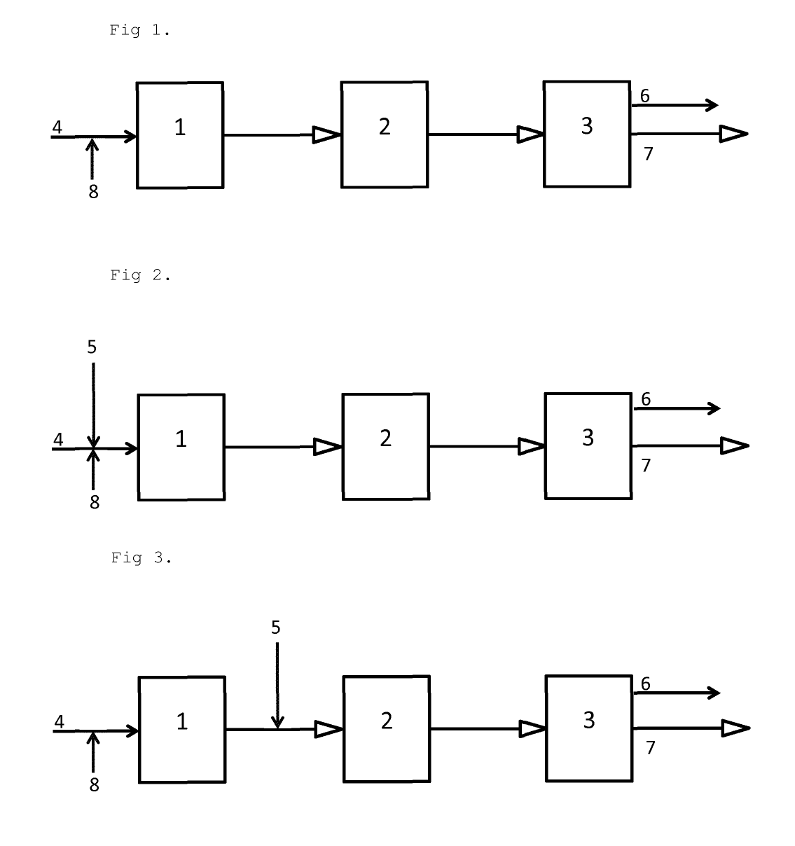

FIG. 2 schematically depicts a system according to the present invention with off gas addition upstream of an SMR reactor.

FIG. 3 schematically depicts a system according to the present invention with off gas addition downstream of the SMR reactor only.

FIGS. 4, 5 and 6 schematically depicts a system according to the present invention with off gas addition both upstream and downstream of the SMR reactor.

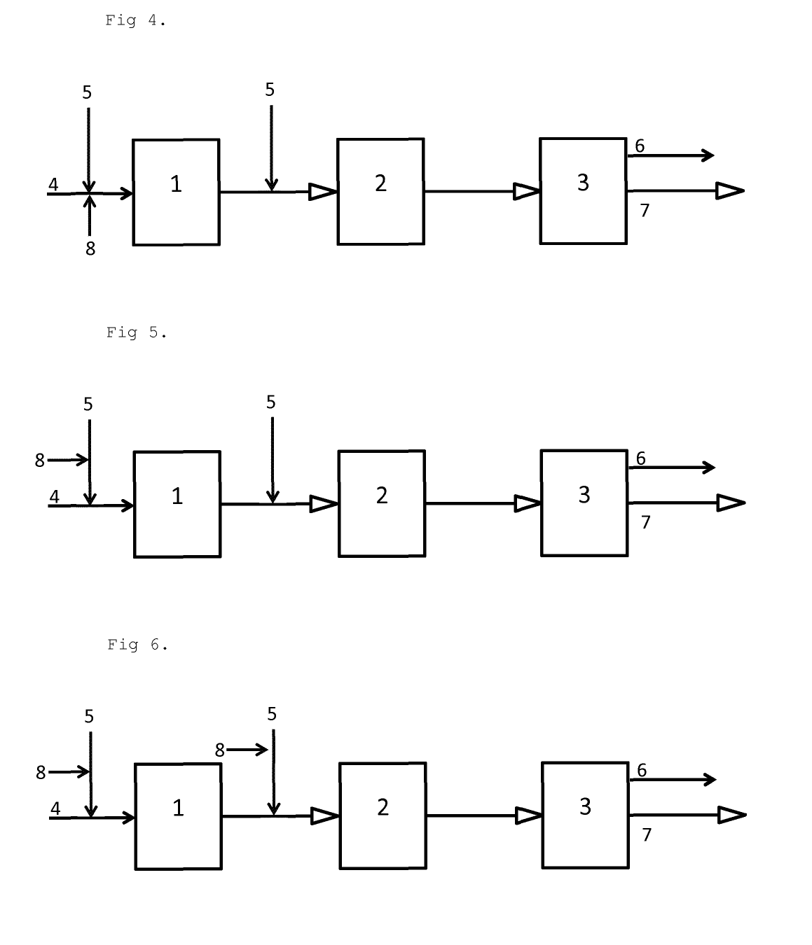

In the figures systems according to the present invention are depicted. In these Figures 1 represents an SMR reactor, 2 CO shift reactor and 3 a PSA unit. Item 4 indicates the natural gas comprising gas stream and 6 the enriched hydrogen gas stream. Item 7 indicates the gas stream comprising the remainder of the constituents (waste stream of the PSA unit). Item 8 depicts the steam stream. In FIGS. 1-4 this stream is added to the natural gas comprising gas stream (4) and in FIG. 5 the steam is added to the off gas stream (5). In addition in FIG. 6 steam is added to the off gas stream downstream of the SMR reactor.

Besides the systems depicted in the figures other options of adding steam are possible, such as adding steam directly to and separately from the off gas, to the first effluent exiting the SMR reactor.

1. A method for obtaining a hydrogen rich gas from a natural gas comprising gas stream, said method comprising the following steps:
(1) feeding said natural gas comprising gas and an appropriate amount of steam to a reforming unit comprising at least a steam methane reformer (SMR) and optionally a pre-reforming reactor up stream of the SMR, obtaining a first effluent;
(2) feeding said first effluent and optionally an appropriate amount of steam through a high, medium or low temperature shift reactor(s) or a combination thereof to convert at least part of the carbon monoxide and water into hydrogen and carbon dioxide, to obtain a second effluent;
(3) optionally, removing bulk water from the second effluent obtained in steps (1) or (2);
(4) feeding the second effluent of step (2) and/or (3) through a pressure swing adsorption (PSA) unit operated such that a hydrogen rich gas stream is obtained wherein an off gas is added to the natural gas comprising gas stream and/or the first effluent obtained in step (1), wherein the off gas provided upstream of the reforming unit is mixed with steam prior to being added to the natural gas comprising gas stream.

2. The method according to claim 1 wherein step 4 comprises the following steps:
(A) feeding the second effluent obtained in step (2) and/or (3) through one or more columns in the PSA unit, said one or more columns comprising an adsorbent bed, wherein the adsorbent bed comprises alumina, a carbon molecular sieve, silicalite, activated carbon, a zeolite, or mixtures thereof,
with upon commencement of said feeding, the bed and column being pre-saturated and pre-pressurized to a pressure in the range of 20 to 80 bar absolute (bar a), and
discharging a third effluent from the other end of said bed, and
continuing said feeding and said discharging until a nitrogen and/or argon comprising gas has reached at least 45% of the length of the bed and has reached at most 80% of the length of the bed, calculated from the end of the bed at which the second effluent is being fed;
(B) ceasing the feeding of the second effluent, and reducing the pressure in the column and the bed by about 2 to 25 bar a; and
(C) further reducing the pressure of the column and adsorbent bed to a pressure in the range of 1 to 5 bar a; and
(D) rinsing the column and adsorbent bed by feeding a gas, through the column and adsorbent bed:
the column and bed being at a pressure in the range of 1 to 5 bar a; and
(E) pressurizing the column and adsorbent bed to a pressure in the range of 15 to 75 bar or comprising 80 to 99.9 volume % hydrogen.

3. The method according to claim 1 wherein said off gas is generated by a synthesis reaction of hydrocarbons from synthesis gas, comprising gas stream and the first effluent obtained in step (1).

4. The method according to claim 1 wherein the off gas is fed through the steam methane reforming reactor in step (1) and/or through the high, medium or low temperature shift reactor(s) in step (2).

5. The method according to claim 3 wherein the off gas comprises (in volume percentage based on the total volume of the off gas):

| | | |
|---|---|---|
| Methane | 1-50 | vol %; |
| Carbon Monoxide | 10-45 | vol %; |
| Carbon Dioxide | 10-65 | vol %; |
| Hydrogen | 5-80 | vol %; |
| Nitrogen | 0.5-55 | vol %; |
| Argon | 0-55 | vol %. |

6. The method according to claim 3 wherein the gas fed to the high, medium or low temperature shift reactor(s) or a combination thereof comprises (in volume percentage based on the total volume of the gas fed):

| | | |
|---|---|---|
| Methane | 1-50 | vol %; |
| Carbon Monoxide | 5-45 | vol %; |
| Carbon Dioxide | 5-65 | vol %; |
| Hydrogen | 5-80 | vol %; |
| Nitrogen | 0.001-55 | vol %; |
| Argon | 0-55 | vol %. |

7. The method according to claim 3 wherein the second effluent comprises (in volume percentage based on the total volume of the second effluent):

| | | |
|---|---|---|
| Methane | 4-20 | vol %; |
| Carbon Monoxide | 1-10 | vol %; |
| Carbon Dioxide | 10-40 | vol %; |
| Hydrogen | 40-95 | vol %; |
| Nitrogen | 0.001-10 | vol %; |
| Argon | 0.0001-5 | vol %. |

8. A system for obtaining a hydrogen rich gas from a gas stream comprising natural gas, comprising, connected in series:
one or more reforming units, each unit comprising at least a pre-reforming reactor and a steam methane reforming reactor and optionally a pre reforming reactor;
one or more high, medium or low temperature shift reactor(s) or a combination thereof to convert at least part of the carbon monoxide and steam into hydrogen and carbon dioxide; and
one or more pressure swing adsorption units.

9. The system according to claim 8 wherein the pressure swing adsorption unit comprises:
one or more columns, comprising an adsorbent bed, wherein the adsorbent bed comprises alumina, a carbon molecular sieve, silicalite, activated carbon, a zeolite, or mixtures thereof.

10. The system according to claim 8 wherein the system comprises upstream of the one or more steam methane reforming reactors an inlet for adding off gas to the natural gas stream wherein the off gas originates from a hydrocarbon synthesis reactor such as a Fischer-Tropsch reactor.

11. The system according to claim 8 wherein the system comprises upstream of one or more high, medium or low temperature shift reactor(s) or a combination thereof, an inlet for adding off gas to the first effluent wherein the off gas originates from a hydrocarbon synthesis reactor such as a Fischer-Tropsch reactor.

12. The system according to claim 8 wherein the system comprises:
a further PSA unit comprising one or more columns provided down-stream of the first PSA unit, said one or more columns comprising an adsorbent bed, the adsorbent bed comprising alumina, a carbon molecular sieve, silicalite, activated carbon, a zeolite, or mixtures thereof.
